(19) United States
(12) Patent Application Publication
(10) Pub. No.: US 2013/0040694 A1
(43) Pub. Date: Feb. 14, 2013

(54) REMOVAL OF USER IDENTIFIED NOISE

(71) Applicants: Babak FORUTANPOUR, Carlsbad, CA (US); Erik VISSER, San Diego, CA (US); Brian MOMEYER, Carlsbad, CA (US); Andre Gustavo P. SCHEVCIW, San Diego, CA (US)

(72) Inventors: Babak FORUTANPOUR, Carlsbad, CA (US); Erik VISSER, San Diego, CA (US); Brian MOMEYER, Carlsbad, CA (US); Andre Gustavo P. SCHEVCIW, San Diego, CA (US)

(21) Appl. No.: 13/207,039

(22) Filed: Aug. 10, 2011

(51) Int. Cl. H04W 88/02

(52) U.S. Cl. 455/550.1

(57) ABSTRACT

Methods, systems and devices enabling a party to a telephone conversation to identify sounds for active filtering so that the identified sound can be actively filtered and/or amplified. Cell phones are provided with a button that allows users to identify sounds for filtering by pressing the button or virtual key when the sound is heard. Sounds recorded in response to such user inputs are processed to identify filtering criteria, such as frequencies and amplitude. The identified filtering criteria are then used to actively filter or enhance sounds. The methods and systems enable user to identify specific sounds for filtering so only those sounds deemed annoying are suppressed while permitting other sounds (e.g., voice) to be heard.

### FIELD OF INVENTION

The methods, systems and devices described below relate to the field of noise filtering in telecommunications, and more particularly to methods, systems and devices for actively identifying and eliminating unwanted background noise in cellular telephone communications.

### BACKGROUND

Cellular and wireless communication technologies have seen explosive growth over the past few years. This growth has been fueled by better communications hardware and larger networks with more reliable protocols that provide an unprecedented freedom of movement to the mobile public, cutting the tether to hardwired communication systems. As a result of this mobility, more cellular phone and wireless device users are using their devices in places where background noise cannot be controlled, such as in family rooms with children present, on construction sites and on busy streets. Consequently, cellular conversations are often interrupted by annoying background noises (e.g., dog barking, a car alarm ringing, etc.) that are transmitted with the users voices.

### SUMMARY

The various embodiments provide systems, devices, and methods for enabling one party to a telephone call or video conference to indicate sounds for filtering, in response to which one or more components in the communication system record the indicated sounds, generate filtering criteria for suppression or enhancing those sounds, and then process subsequent communications to suppress or enhance sound. For example, a first user may designate noise for filtering by pressing a push-to-hush button on the user's phone. This action prompts the user's phone, the other party's phone or a communication component in the intervening network to record sound present while the button is pressed and/or for a certain amount of time thereafter. One of the components in the communication network (either phone or an intermediate component) may analyze the recorded sound, such as to identify frequency, harmonic and amplitude characteristics that can then be used to filter (suppress or enhance) the sound from subsequent communications. Enabling the user to designate sounds for filtering enables generation and use of very specific noise filtering mechanisms (i.e., specific to the annoying or pleasing sound identified by a user). The embodiments also enable the person on the receiving side who is most likely to be bother by the background noise to designate the sounds for filtering, thereby enabling the parties to the conversation to initiate active sound filtering according to their preferences.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating a cellular communication system suitable for use in an embodiment.

FIG. 2 is an illustration of a mobile communication device showing a user interface that may be used in accordance with the various embodiments.

FIG. 3 is communication system of an example communication link between a first party (caller A), second party (caller B) and a third party (caller C).

FIGS. 4-10 are time and frequency diagrams illustrating exemplary sound analysis and filtering techniques applied to human speech corrupted by a car horn noise in accordance with the various embodiments.

FIGS. 11-14 are process flow diagrams of example methods for removing background noises in accordance with the various embodiments.

FIG. 15 is a component block diagram of a receiver device suitable for use in an embodiment.

FIG. 16 is a component block diagram of a server device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “cell phone” and “mobile device” are used interchangeably herein to refer to any one or all of telephones, cellular telephones, smart-phones (e.g., iphone), multimedia Internet enabled cellular telephones (e.g., the Blackberry Storm®), personal data assistants (PDA's), laptop computers, personal computers, receivers within vehicles (e.g., automobiles) and similar electronic devices. However, the terms “cell phone” and “mobile device” should not be limited to the enumerated list of devices and may include any device capable of controlling a transducer and/or receiving audio files or si.

As used herein the term “file” refers to any of a wide variety of data structures, assemblages of data and database files which may be stored on a computing device.

The various embodiments provide methods, devices and systems for identifying and filtering background noises during a telephone/videophone conversation. As most have experienced, there are times when it is difficult to hold a conversation over a cell phone due to background noises. Current methods for reducing background noises cannot target a particular noise that a user finds annoying (e.g., car alarm, baby crying, barking dog, etc) while allowing other background noises (e.g., children laughing) to be transmitted along with the user's voice. Existing noise cancellation systems have no mechanisms for differentiating between sounds that a user finds annoying and those that the user wants to hear.

The various embodiments enable any party in a telephone conversation to identify and label sounds as being either annoying or pleasant so that the identified sound can be actively filtered and/or amplified. The embodiments enable the listener to indentify a sound by providing a user input option (e.g., a physical or virtual button) that can be pressed when the user hears the annoying (or pleasant) sound. The system analyzes sound while the input is depressed, and uses the result to actively filter the rest of the telephone conversation. By allowing the listeners to actively identify the sounds for filtering, noise filtering/amplification mechanisms may focus their processing on the identified sounds and remove only those sounds deemed annoying, amplify those sounds deemed pleasant, and/or permit all other sounds (e.g., voice) to be heard without any filtering.

In an embodiment, the phones may be configured such that pressing a push-to-hush button on a far-end phone (e.g., a phone in a different location than the source of the background noise) causes a near-end phone (e.g., a phone in the location of the background noise) to capture and filter the sounds before transmission. In other embodiments, the near-end phone captures and transmits the sounds without modification and the phones may be configured such that pressing a push-to-hush button on a far-end phone causes a server or the far-end phone to filter the sounds so they are not produced by the far-end phone. Thus, in the various embodiments, a phone on which the push-to-hush button was pressed (e.g., far-end phone) may capture and filter the sounds, instruct another phone (e.g., near-end phone) to sample and capture the sound, and/or instruct another component (e.g., near-end phone, server) to filter the sounds. In any case, one of the phones captures the sound, digitizes the sound and stores it in a memory, and the stored sounds are analyzed by a component in the communications link (e.g., near end phone 304, far end phone 302 or server 314 in between the phones) to generate filtering criteria (e.g., frequency and harmonic components). The stored sounds may be analyzed using known sound analysis techniques, such as to identifying frequencies, amplitudes, and time-varying patterns that characterize the sound or which can otherwise be used to filter out and/or amplify the recorded sounds

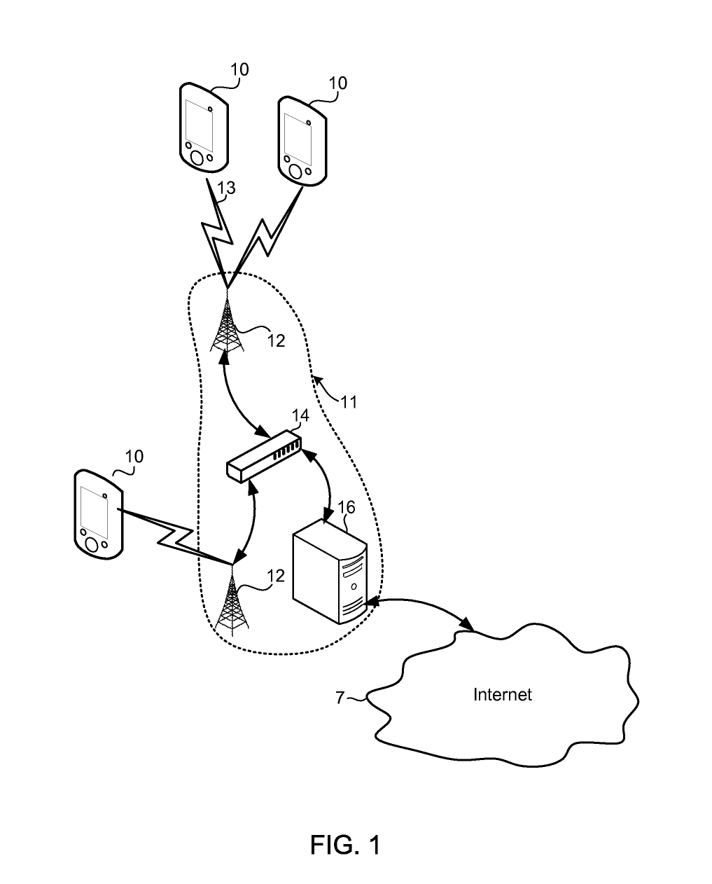

The various embodiments may be implemented within a variety of communication systems, such as a cellular telephone network, an example of which is illustrated in FIG. 1. A typical cellular telephone network 11 includes a plurality of cellular base stations 12 coupled to a network operations center 14, which operates to connect voice and data calls between mobile devices 10 (e.g., mobile phones) and other network destinations, such as via telephone land lines (e.g., a POTS network, not shown) and the Internet 7. Communications between the mobile devices 10 and the network 11 are accomplished via two-way wireless communication links 13, such as 4G, 3G, CDMA, TDMA, and other cellular telephone communication technologies. The network 11 may also include one or more servers 16 coupled to or within the network operations center 14 that provide a connection to the Internet 7 and/or are used to perform additional signal processing on the signals, such as removing background noise.

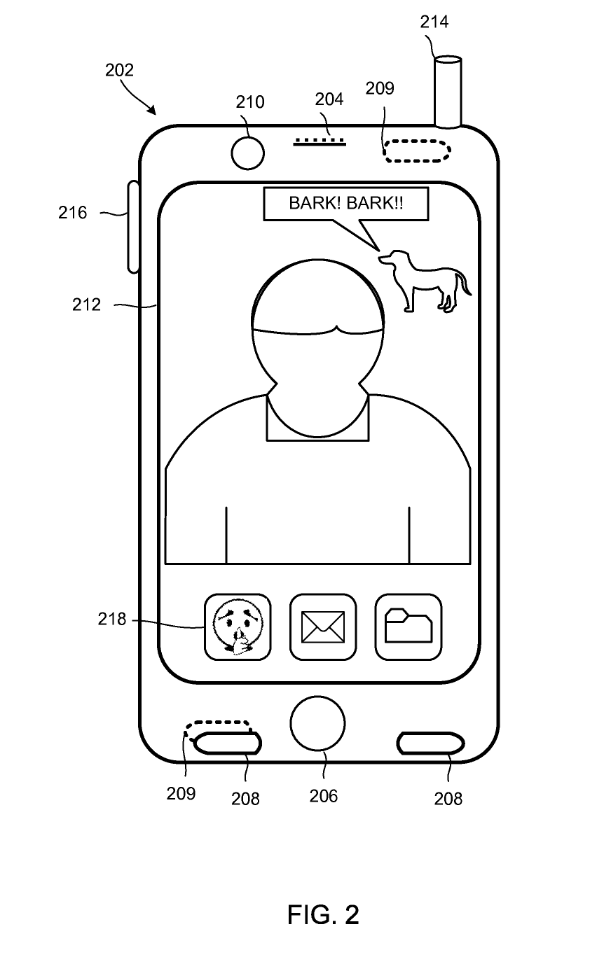

FIG. 2 illustrates sample components of a cell phone 202 that may be used with the various embodiments. The cell phone 202 may include a speaker 204, a menu selection button 206 for receiving user inputs, one or more front-side microphones and/or microphone arrays 208 for capturing directional sounds, one or more back-side microphones and/or microphone arrays 209 for capturing directional sounds present behind the phone, an antenna 214 for sending and receiving electromagnetic radiation, a camera 210 and a display 212 for video conferencing and/or receiving user inputs. The phone may also include one or more user interface elements 216, 218 (e.g., buttons), for initiating the process of sampling disturbing/pleasing sounds. The user interface elements 216, 218 (e.g., buttons) may be implemented as hard key buttons, soft key buttons, as a touch keys, or any other way of receiving user input for initiating the sampling of sounds.

For ease of reference, the user interface elements 216, 218 are referred to herein as “push-to-hush” or “push-to-amplify” buttons. The term “push-to-hush button” is used herein to describe a user interface element (e.g., buttons 216, 218) that allows users to initiate the sampling of unwanted or “annoying” background sounds and/or “wanted” (e.g., voice) sounds, and the term “push-to-amplify button” is used to describe a user interface element that allows user to initiate the sampling of background sounds for amplification. However, a single “push-to-hush button” may be associated all of the above-mentioned elements/operations. Therefore, it should be understood that the terms “push-to-hush” and “push-to-amplify,” are used generically and interchangeably in this application to describe any user interface element (e.g., button) that initiates the sampling of sounds and the use of these terms should not be used to limit the scope of the claims.

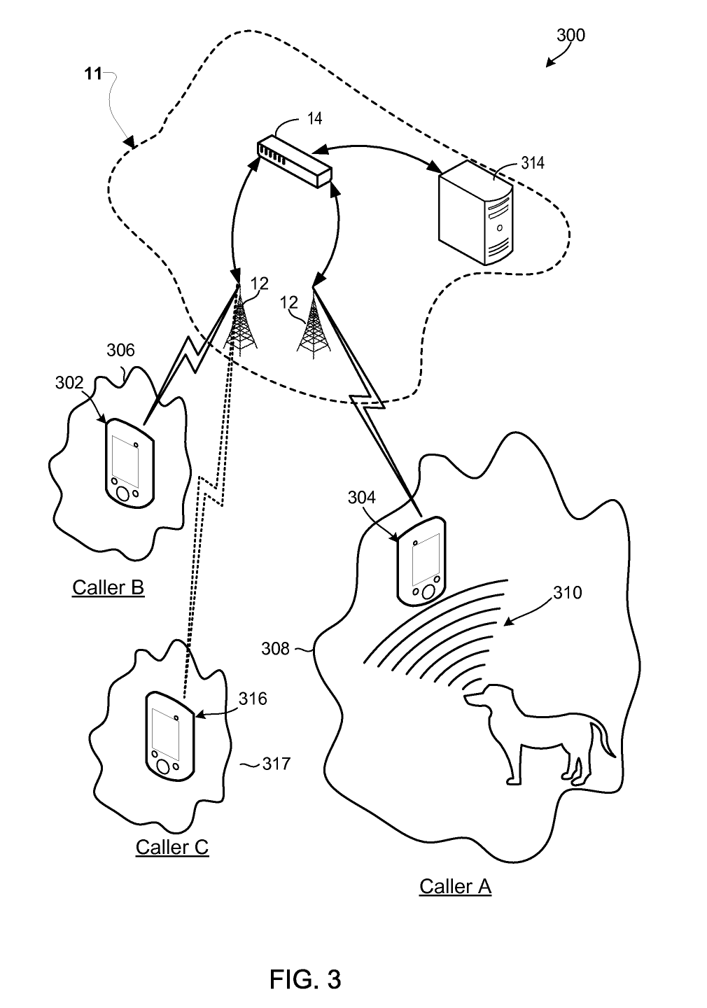

FIG. 3 illustrates an example communication link between a first party (caller A), second party (caller B) and a third party (caller C). In the illustrated example, a first party (caller A) uses a “near end” phone 304 in a location 308 having background noises 310. In this example, background noises 310 are picked up by the phone 304 and transmitted to a second party (caller B) using a first “far end” phone 302 (e.g., a phone that is remote from the source of the background noise) at a second location 306 and/or a third party (caller C) using a second “far end” phone 316 at a third location 317.

As discussed above with reference to FIG. 2, one or more of the phones 302, 304, 316 may include a “push-to-hush” button for indicating unwanted background noises 310. Pressing the push-to-hush button initiates the processes of sampling background noises 310, digitizing the sampled sounds, and storing of the digitized sounds in a memory and/or filter the sounds before transmission. Pressing the push-to-hush button may also instruct one or more components in the communication system (e.g., a near end phone 304, far end phone 302 or server 314 in between) to filter/amplify and/or otherwise manipulate sounds based on the filter criteria. For example, if during a call, caller B finds that the background noise 310 is bothersome, caller B may indicate to caller A that there is an annoying background noise, halt his or her conversation, and press the push-to-hush button on the far end phone 302 to initiate a sound capture process, which may be initiated by any component in the communication link, discussed in detail further below. In this example, pressing the push-to-hush button on caller C's phone 302 may instruct caller A's phone 304 (or any component in the communication link) to detect and capture all sounds, either for the duration that the button is pressed or for a certain amount of time thereafter. In another embodiment, caller A may remove the background noise by halting his or her conversation and pressing the push-to-hush button on caller A's phone 304. In any case, the pressing of the push-to-hush button initiates the sound capture process.

Captured sounds may be labeled as being good or annoying via their storage in one or more memories dedicated to each labeling category. For example, each of the components in the communication link (e.g., near end phone 304, far end phones 302, 316 or server 314 in between the phones) may contain a “good” memory (e.g., a buffer) and a “bad” memory. Sounds indicated as being annoying or unwanted (e.g., by pressing the push-to-hush button) may be placed in the “bad” memory. Likewise, sounds may be labeled as wanted via their storage in the good memory. In an embodiment, the sounds that are to be amplified (e.g., sounds indicated as “pleasing” via a pressing of a push-to-amplify button or virtual button) may be stored in an “amplify” memory. Each of the bad, good and amplify memories may be a portion of the device memory that has been reserved for audio samples that are annoying, wanted, or to be amplified, respectively.

In various embodiments, the cellular phones 302, 304, 316 may be configured to capture “good sounds” at various times. A user may indicate or record wanted sounds by pressing and/or holding the push-to-hush button while a wanted sound is heard, such as while one or more parties to the conversation is speaking. The phones 302, 304, 316 may capture these sounds and store them in the “good” memory (e.g., good buffer). In an embodiment, the cellular phones 302, 304, 316 may be configured to automatically sample sounds for an amount of time (e.g., 500 milliseconds, 1 second, 2 seconds, etc.) before and/or after an identified “bad” sound is captured and store these sampled sounds in the “good” memory. For example, the cellular phones 302, 304, 316 may be configured (e.g., via a user setting) to automatically sample sounds for a configurable amount of time (e.g., 500 milliseconds, 1 second, 2 seconds, etc.) after the pressing of the push-to-hush button (i.e., after the initiation of the “bad” sound capture process) and store these sampled sounds in the “good” memory. In an embodiment, the cellular phones 302, 304, 316 may be configured to prompt the user to capture sounds to be stored in the “good” memory by pressing the push-to-hush button at a designated time. In an embodiment, the sampling of sounds to be stored in the “good” memory may be initiated after the push-to-hush button is pressed a certain number of times. For example, the phone may be configured such that the first three times the push-to-hush button is pressed, the captured sounds are stored in the “bad” memory, and the next three times the push-to-hush button is pressed the captured sounds are stored in the “good” memory.

In an embodiment, the cellular phones 302, 304, 316 may be configured to capture sounds to be amplified and store them in an “amplify” memory. In an embodiment, the “amply” memory may stored sounds captured in response to the user pressing the “push-to-amplify” button. In an embodiment, any component in the communication link (i.e., the near-end phone, far-end phone, or server in between) may amplify sound signals matching the frequency range of sounds received and/or transmitted over the air. It should be noted that, in the various embodiment, the “amplify” memory may be completely distinct from the above-mentioned “good” and “bad” memories and store only sounds that are to be amplified. In various embodiments, both the “good” memory and the “bad” memory may be used to for noise suppression.

In an embodiment, captured sounds may be stored in a temporary buffer while a mobile device user labels the captured sound as “wanted,” “amplify” or “annoying.” For example, sounds may be stored in a temporary buffer while a mobile phone display prompts the user with options such as “hush,” “pleasant,” “wanted,” “voice” and “amplify.” Based on the user's selection, the sounds may be transferred from the temporary buffer to the appropriate memory (e.g., good, bad, amplify).

The system may use intelligence to recognize when an identified sound may encompass the sounds of speech, and behave appropriately. The system may be configured such that sounds that overlay normal speech are not filtered and/or amplified. In an embodiment, the sounds may be filtered only briefly to enable speech to be heard while reducing the background sound. In an embodiment, the filtering device (near end phone, far end phone or server in between) may recognize when a person is talking and not talking and filter out the background noise overlaying speech sounds only when it determines the person is not talking.

Sounds stored in the “good” and “bad” memories may be used to determine what sounds are background sounds (e.g., dog barking, children laughing) and what sounds are foreground sounds (e.g., caller's voice). A background-foreground separation process (e.g., software executed by a device processor, circuit logic embedded within a processor, etc.) may determine if the identified background sounds may be filtered based the identified foreground sounds. For example, a device processor may determine if sounds stored in the different memories have different spectral frequencies in relation to one another and/or if the stored sounds have a different spectral frequency than that of the sounds transmitted when the button is no longer pressed (e.g., normal conversation). The device processor may also determine whether the sounds are different enough so that they can be removed/amplified without significant distortions. If it is determined that it is possible to filter the background sounds from the foreground sounds without significant distortion, the sounds may be separated for filtering and/or amplification. However, if it is determined that the sounds are too similar (e.g., a car horn is too similar to the sound caller A's voice) the system may choose not to filter the sounds and no additional filtering/amplification is performed.

In various embodiments, the labeling of the sounds as being “pleasant,” “annoying” or “amplify” may be based on the configuration of the push-to-hush button. For example, if caller B wants to hear the background noise more clearly, he/she may configure the push-to-hush button such that pressing the button indicates that background noises are “pleasant.” In another embodiment, a second push-to-hush button (e.g., a push-to-amplify button) may be used to differentiate background noises deemed annoying from background noises deemed pleasant. Thus, the memories may be chosen based on the button pressed (e.g., push to hush, push to amplify, etc.) or based on the configuration (hush, pleasant, amplify, etc.) of the push-to-hush button.

In an embodiment, the system may determine which sounds are to be placed in a bad buffer and which sounds are to be placed in a good buffer based on user input, user preferences, usage history, and/or direction of incoming sound. The sounds stored in the memories may be used to determine what sounds are background sounds (e.g., dog barking, children laughing) and what sounds are foreground sounds (e.g., caller's voice). A background-foreground filtering algorithm may be executed to determine if the identified background sounds may be separated from the identified foreground sounds. If it is determined that it is possible to separate the background sounds from the foreground sounds, the sounds may be filtered and/or amplified. However, if it is determined that the sounds are too similar (e.g., a car honking is too similar to the sound caller A's voice) the system may choose not to filter the sounds and no additional filtering/amplification is performed.

As discussed above with reference to FIG. 2, the phones may include one or more microphone arrays for capturing directional sounds. In the various embodiments, the phones may be configured to use the directional aspects of the multiple microphone arrays to correlate the pressing of the push-to-hush button with the direction of sound energy entering the phone. For example, a phone located at the site of the background noise (e.g., caller A's phone) may identify the sounds to be eliminated and/or amplified (e.g., via one of the users pressing the push-to-hush button) by determining the directionality of the sound entering the phone and executing a directional microphone algorithm on the identified sound to select one or more of the microphone arrays. In this manner, the phones may determine what sounds to place in the memories by selecting the microphone arrays that best suit the directionality of wanted and unwanted noises. In an embodiment, the multiple microphone arrays may be used to designate different sound arrays that have different look and null directions. For example, a filtering mechanism may use microphone beam steering techniques to actively steer a null beam in the direction of unwanted noise.

In an embodiment, the user on the near end phone 304 (caller A) may press the push-to-hush button to control the selection of microphone arrays on the near end phone 304 (caller A). In another embodiment, the user on the far end phone 302 (caller B) may press the push-to-hush button to control the selection of microphone arrays on the near end phone 304 (caller A). In this embodiment, the pushing of the push-to-hush button on the far end phone 302 transmits a signal to the near end phone 304 (caller A) via the cellular communication link instructing the near end phone 304 to sample the wanted/unwanted sounds and determine which microphone arrays to select.

In the various embodiments, the system may use intelligence to recognize when an identified sound may encompass the sounds of speech. For example, in an embodiment, the system may be configured such that sounds that overlay normal speech are not filtered and/or amplified. In various embodiments, the sounds may be filtered only briefly to enable speech to be heard while reducing the background sound. In an embodiment, the filtering device (near end phone, far end phone or server in between) may recognize when a person is talking and not talking and filter out the background noise overlaying speech sounds only when it determines the person is not talking.

As previously discussed, caller A may remove the background noise by halting the conversation and pressing a push-to-hush button on caller A's phone 304, which instructs caller A's phone 304 to detect and capture all sound present while the button is pressed and/or for a certain amount of time thereafter. In another embodiment, caller B may remove the sounds directly by simply asking caller A to momentarily stop speaking while caller B presses a push-to-hush button located on caller B's phone 302. In this scenario, caller B is the “husher” and the caller B's phone 302 may initiate the capture of the background noise 310. In yet another embodiment, pressing the push-to-hush button on either phone 302, 304 may instruct a server 314 (e.g., a server in the communications link between the two phones) to initiate the sound capture process and to filter the noise. Thus, in the various embodiments, pressing a push-to-hush button on any one of the phones 302, 304 may instruct one or more components within the communications link (e.g., near end phone 304, far end phone 302 or server 314 in between the phones) to sample background noises and/or filter the background noises.

The filtering of sounds may occur either before the transmission of the signal or after the transmission of the signal. For example, the near-end phone 304 may actively sample the background sounds and filter the sounds before transmitting the signal. Alternatively, the far-end phone 302 may actively sample the background sounds and filter the sounds after the signal is received from the near-end phone 304.

In an embodiment, the phones may be configured such that pressing the push-to-hush button on a far-end phone 302, 316 causes the near-end phone 304 to capture and filter the sounds before transmission. In other embodiments, the near-end 304 phone captures and transmits the sounds without modification and the phones may be configured such that pressing a push-to-hush button on a far-end phone 302, 316, causes a server 314 or the far-end phone 302, 316 to filter the sounds so they are not produced by the far-end phone 302,316. Thus, in the various embodiments, a phone on which the push-to-hush button was pressed (e.g., far-end phone 302) may capture and filter the sounds, instruct another phone (e.g., near-end phone 304) to sample and capture the sound, and/or instruct another component (e.g., near-end phone 304, server 314) to filter the sounds. In any case, one of the phones 302, 304 captures the sound, digitizes the sound and stores it in a memory, and the stored sounds are analyzed by a component in the communications link (e.g., near end phone 304, far end phone 302 or server 314 in between the phones) to generate filtering criteria (e.g., frequency and harmonic components). The stored sounds may be analyzed using known sound analysis techniques, such as to identifying frequencies, amplitudes, and time-varying patterns that characterize the sound or which can otherwise be used to filter out and/or amplify the recorded sounds.

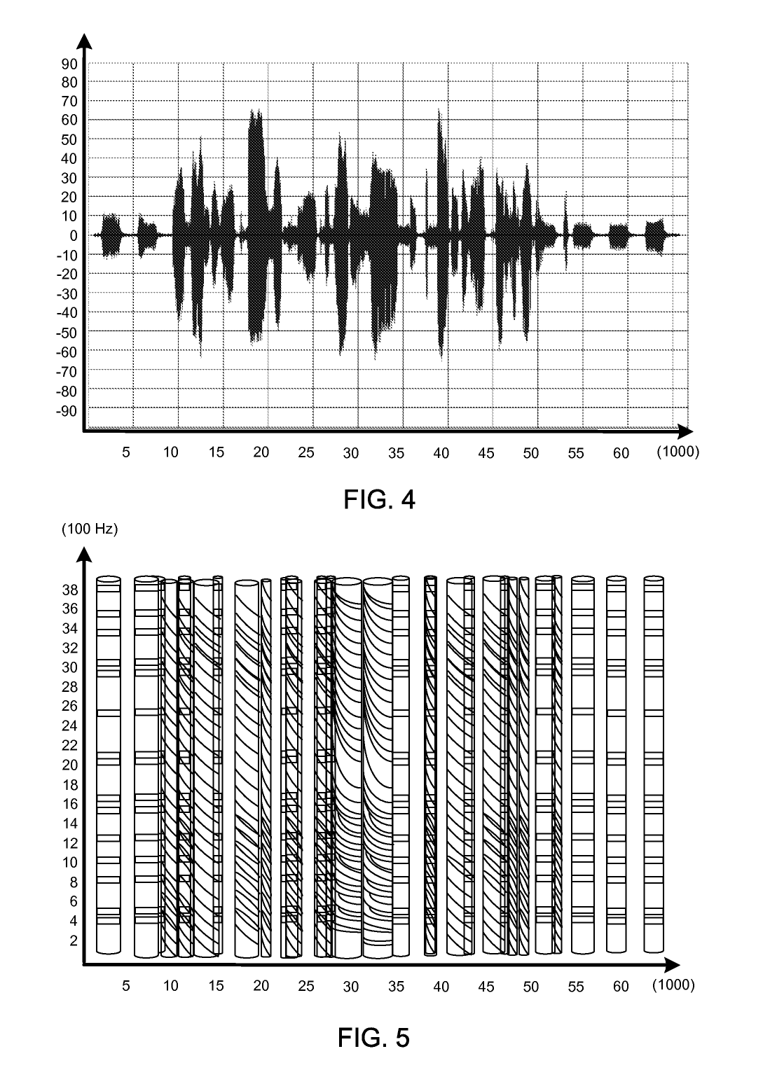

FIGS. 4-10 illustrate exemplary results of sound analysis and filtering techniques, applied to human speech corrupted by a car horn noise, which may be used in accordance with the various embodiments. FIG. 4 illustrates both signals (i.e., human speech and car horn noise) in the time domain. FIG. 5 illustrates the same signals (i.e., the same human speech and car horn noise), in the frequency domain. A comparison of FIG. 4 and FIG. 5 illustrates that the human speech and car horn noise have a similar harmonic structure but big differences in underlying pitch frequencies. The various embodiments exploit the differences in pitch frequencies to identify characteristics that can be used to filter the different signals.

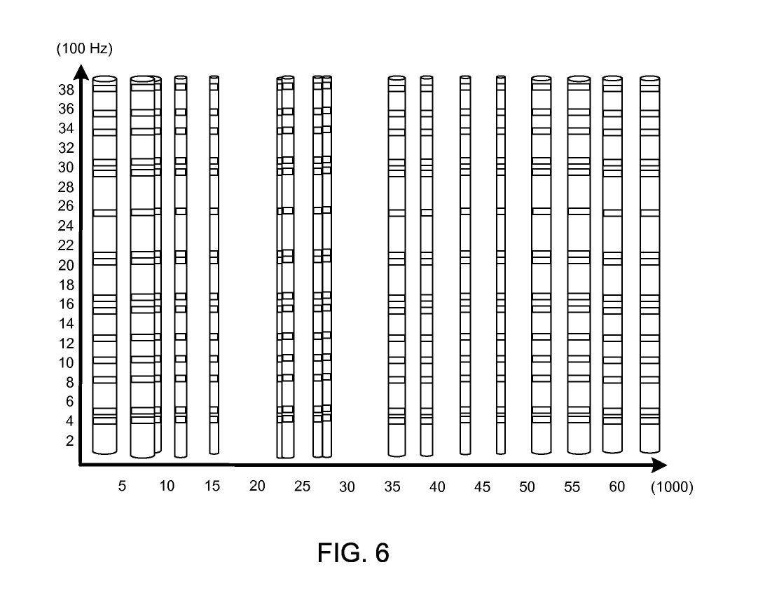

As discussed above, current methods for reducing background noises cannot target a particular noise that a user finds annoying (e.g., car horn), and as a result, are unable to differentiate between sounds that a user finds annoying and those that the user wants to hear. By allowing users to actively identify and label the sounds, the various embodiments enable noise filtering/amplification mechanisms to focus their processing on the identified sounds and remove only those sounds deemed annoying, amplify only those sounds deemed pleasant, and/or permit all other (e.g., voice) sounds to be heard without any filtering. For instance, in the illustrated example of FIGS. 4-12, the far-end user or the near-end user may label time intervals during which the desired and undesired sounds are clearly differentiated from each other (e.g., by halting the conversation and pressing the push-to-hush button). This allows the analyzing component (e.g., near end phone 304, far end phone 302 or server 314) to extract an unwanted noise labeling time profile, such as the noise labeling frequency profile illustrated in FIG. 6.

FIG. 6 illustrates the frequency domain noise patterns associated with labeled time-frequency intervals of the identified undesired noise pattern (e.g., car horn noise pattern). Frequency domain noise patterns may be determined by comparing the sounds stored in the buffers (e.g., the good, bad, and neural buffers discussed above) with the combined signal (e.g., the speech and noise signal). This comparison may be used to identify the background sounds (e.g., car horn). If background sounds are identified, a background-foreground filtering process may be executed to determine if the identified background sounds may be filtered out from the identified foreground sounds. If it is determined that the sounds are too similar (e.g., a car horn is too similar to the sound caller A's voice) the system may choose not to filter the sounds and may request the user to capture more samples (e.g., press the push-to-hush button again the next time the car horns). However, if it is determined that it is possible to filter the background sounds from the foreground sounds without significant sound distortions, the analyzing component (e.g., near end phone 304, far end phone 302 or server 314) may filter the sounds so that the far end user only hears the desired sounds.

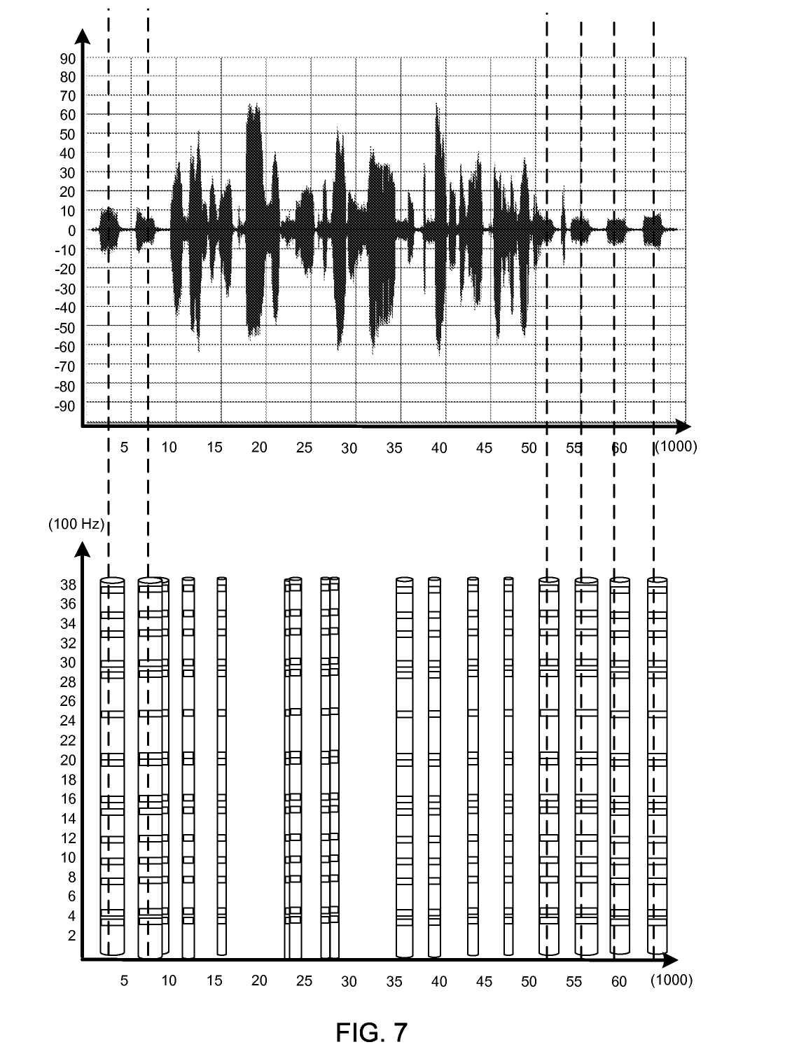

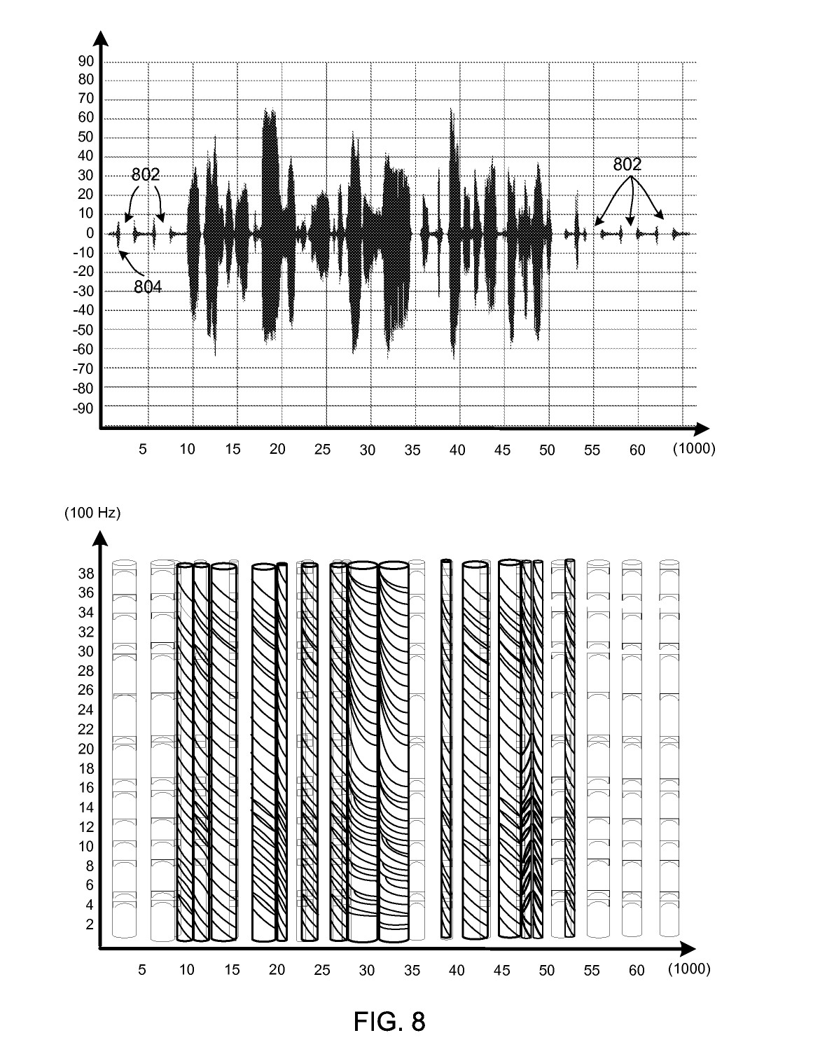

FIG. 7 illustrates the relationship between the frequency domain noise patterns illustrated in FIG. 6 and the time domain representation of the combined human speech and car horn noise signal illustrated in FIG. 4. FIG. 8 is a combined time-domain and frequency domain graph illustrating an example in which the undesired noise pattern (e.g., car horn noise pattern) is identified and suppressed in the identified intervals. As can be seen in FIG. 8, the identified car horn noise may be suppressed or subtracted from portions 802 of the combined signal. FIG. 8 also illustrates that, while suppressing the identified interval results in some noise suppression (e.g., removed portions 802), some residual noise 804 may remain, such as at the noise onset and offset. Enhancing the voice signal based on a partially identified noise signature may also result in some residual noise remaining present in the combined signal (e.g., human speech and car horn noise) that may not be easily removed.

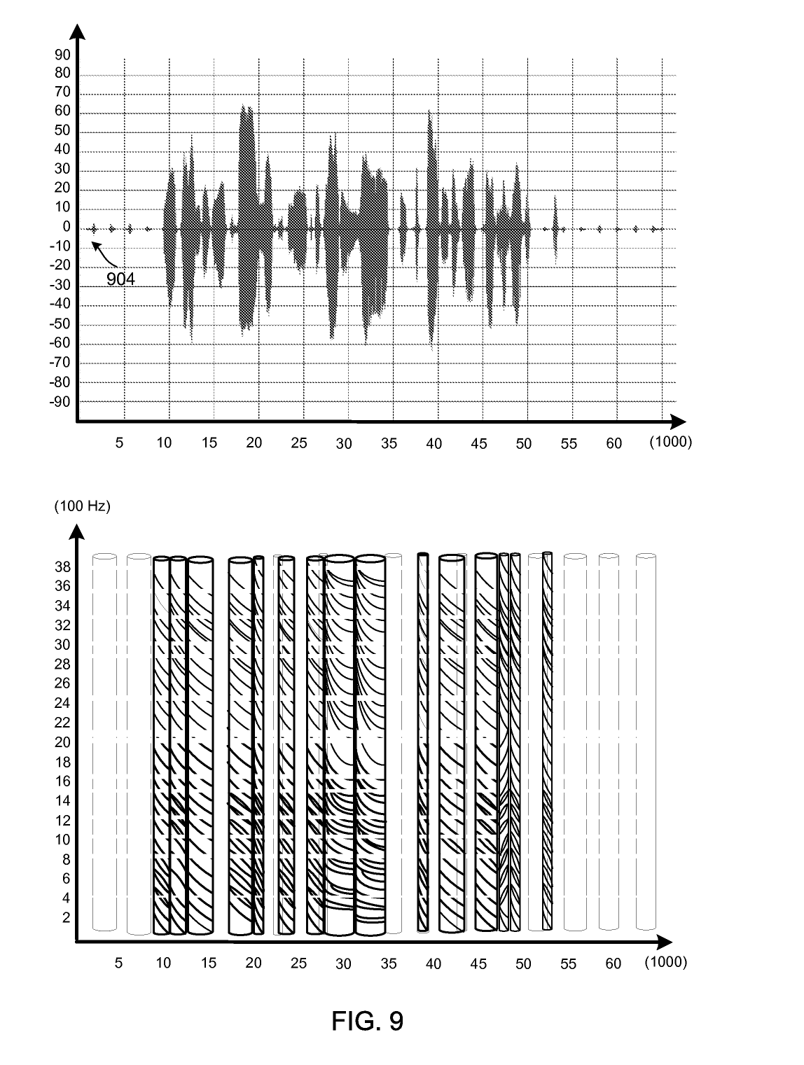

If it is determined that the residual noise volume is more than a preset threshold value, the mobile device may prompt the user to capture more sound samples for one or more categories of labeled sounds (e.g., good, bad). For example, in an embodiment, the phone on which the push-to-hush button was pressed may be configured to prompt the user to repress the button at the next occurrence of the sound (e.g., the next time the car horn sounds) to capture additional sound samples. These additional samples allow the analyzing component (e.g., near end phone 304, far end phone 302 or server 314) refine filtering criteria in order to more narrowly target the undesirable sounds. By labeling precise intervals of unwanted sound (e.g., via taking and analyzing additional sound samples), the noise signature of the unwanted sound becomes more readily identifiable, allowing the filtering mechanism to better suppress the undesired noise without significantly impacting the voice signal, resulting in better noise reduction than existing solutions. This improved noise reduction is illustrated by FIG. 9.

FIG. 9 is a combined time-domain and frequency domain graph illustrating example filtering results when the undesired noise pattern is identified and suppressed at all times. As discussed above, by capturing and labeling multiple instances of desired sounds (e.g., pleasant) and multiple instances of undesired sounds (e.g., annoying), the various embodiments allow an analyzing component (e.g., near end phone 304, far end phone 302 or server 314) to narrowly target its filter processing so that the undesired noise may be suppressed at all times without significantly impacting the desired sounds. As illustrated in FIG. 9, the time and frequency domain visualizations of the voice signal using more accurately labeled noise intervals allows for noise suppression. This allows the background noise to be removed without significant residual noise 804. Enhancing the voice signal based on a more refined noise signature results in less residual noise remaining in the combined signal.

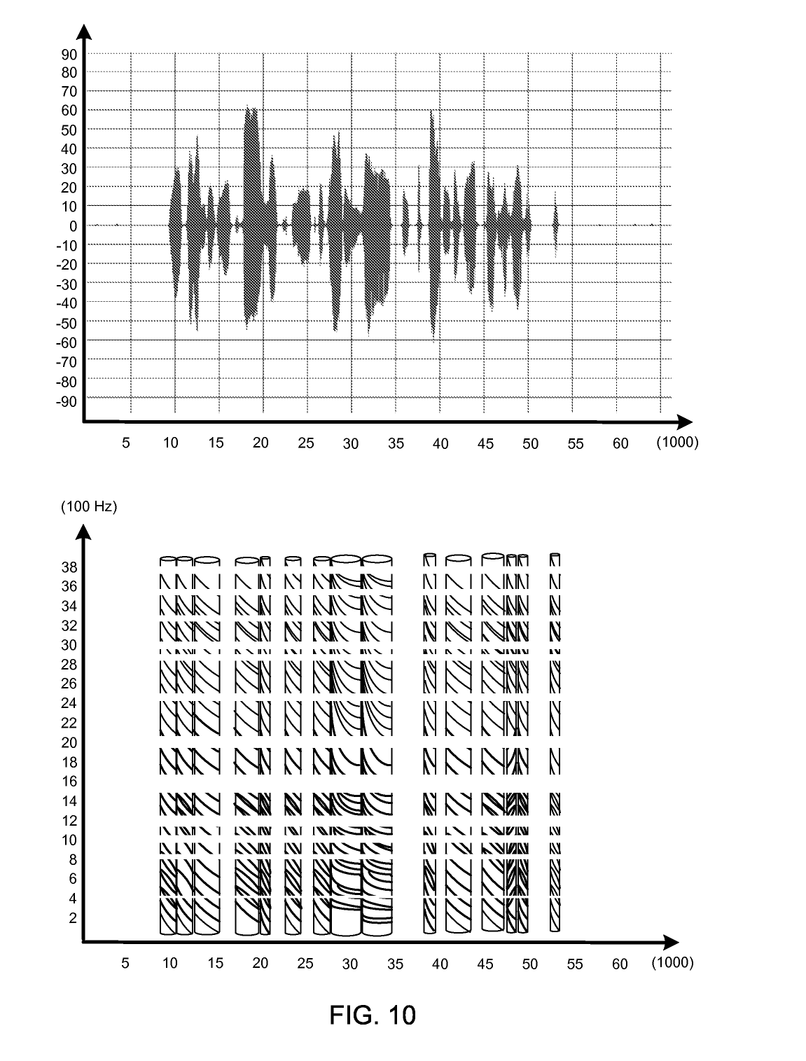

Aggressively filtering background noise may result in filtering out some speech sounds, as represented by gaps in the frequency domain of FIGS. 9 and 10. FIG. 10 illustrates the time and frequency domain visualizations of an aggressively enhanced voice signal using more accurately labeled noise intervals and noise suppression at all points in time. FIG. 10 illustrates that the speech sounds are partially suppressed as the background noise is completely suppressed. This is especially the case when the spectrum of noise and speech exhibit similar patterns. In the various embodiments, the analyzing component may determine the level of filtering based on the level of speech sound suppression being below a preset threshold. For example, in an embodiment, the analyzing component may increase the level of filtering until it is determined that the speech sounds suppressed is likely to be bothersome to the listener. In the various embodiments, the threshold value for speech sound suppression may be a user configurable property or may be set based on usage or user preference.

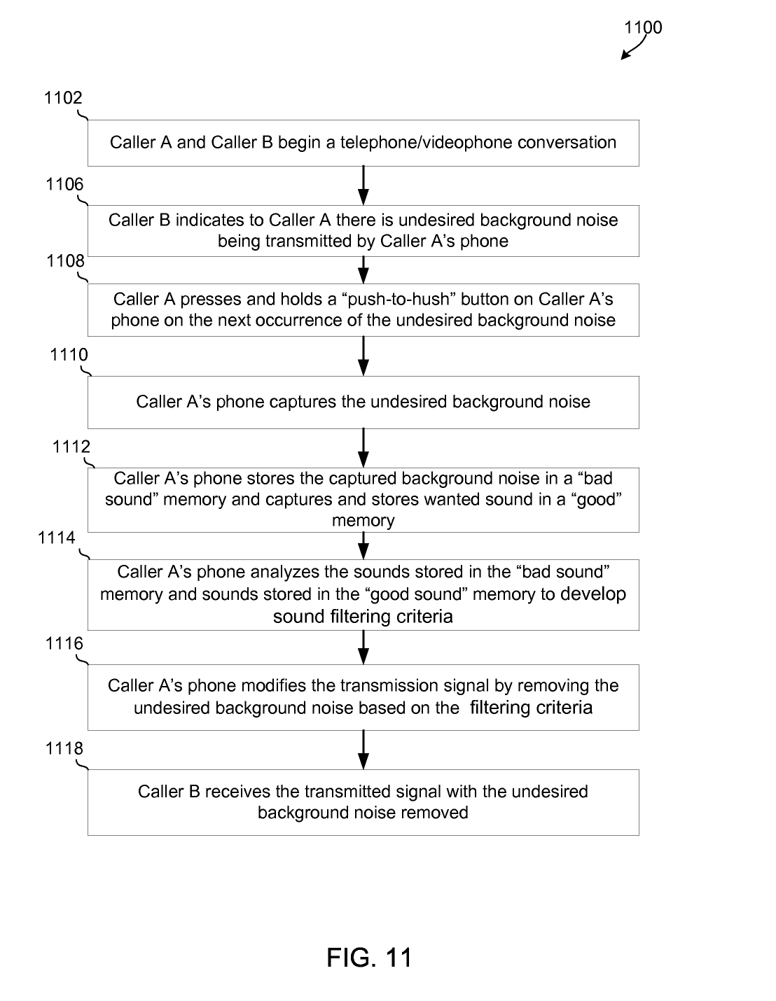

An embodiment method 1100 for removing background noises from a communication link is illustrated in FIG. 11. In block 1102, caller A may begin a telephone and/or videophone conversation with caller B. In block 1106, caller B may indicate to caller A that there is an annoying background noise and request caller A remove the noise. In block 1108, caller A may halt his or her conversation and press the push-to-hush button on caller A's phone during the next occurrence of the sound. In block 1110, the pressing of the push-to-hush button on caller A's phone instructs caller A's phone to detect and capture background sounds. In block 1112, caller A's phone captures the background sounds, either for the duration that the button is pressed or for a certain amount of time thereafter, and stores the background sounds in “bad” memory. In various embodiments, caller A's phone may prompt the user (or otherwise require/request) additional background samples (e.g., a total of three background sound samples) be captured and stored in the “bad” memory. Caller A's phone may also capture wanted sounds (e.g., voice) and store the wanted sounds in a “good” memory. In an embodiment, caller A's phone may capture wanted sounds in response to the user to pressing the push-to-hush button, such as while the user speaks into the microphone. In an embodiment, caller A's phone may capture wanted sounds by automatically capturing all sounds occurring for a period of time (e.g., 500 milliseconds, 1 second, etc.) after the push-to-hush button is pressed. In an embodiment, caller A's phone may configured to store sounds captured in response to a first number of pressings (e.g., 3 pressings) of the push-to-hush button in the “bad” memory and store in the “good” memory sounds captured in response to an additional number of pressings (e.g., the 4^{th}-6^{th} pressings) occurring within a certain amount of time (e.g., 10 seconds, 30 seconds, etc.) after the first number of pressings.

Returning to FIG. 11, in block 1114, caller A's phone analyzes and compares the sounds stored in the “bad sound” memory and sounds stored in the “good sound” memory to generate filtering criteria. In block 1116, caller A's phone modifies the transmission signal by using the generated filtering criteria to filter out the undesired background noise and sends the modified signal to caller B. This filtering may be performed by the CODEC or by digital signal processing of the digital output from the CODEC. In block 1118, caller B receives the transmitted signal with the undesired background noise removed. Thus, in method 1100, caller A presses the push-to-hush button and caller A's phone removes the background noise.

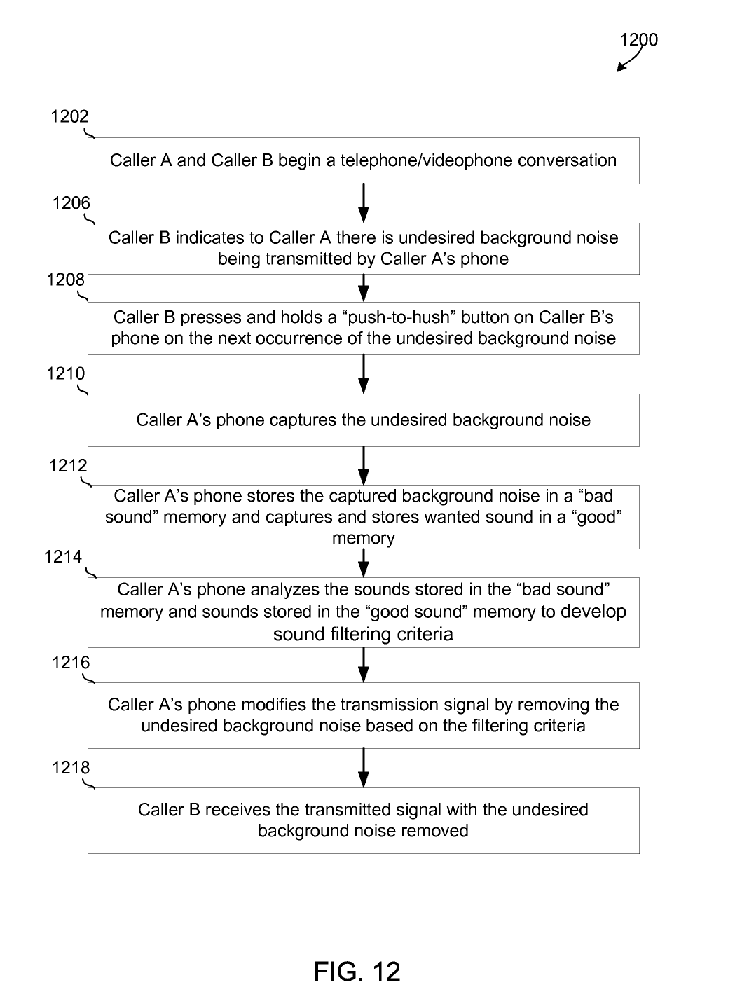

Another embodiment method 1200 for removing background is illustrated in FIG. 12. In block 1202, caller A may begin a telephone and/or videophone conversation with and caller B. In block 1206, caller B may indicate to caller A that there is an annoying background noise being transmitted by caller A's phone and request caller A to momentarily remain quite while caller B presses the push-to-hush button. In block 1208, caller B presses and holds a “push-to-hush” button on caller B's phone during the next occurrence of the undesired background noise. In block 1210, the pressing of the push-to-hush button on caller B's phone instructs caller A's phone to detect and capture background sounds. In block 1212, caller A's phone captures the background sounds, either for the duration that the button is pressed or for a certain amount of time thereafter. Caller A's phone may also capture wanted sounds (e.g., voice), either in response to another pressing of the push-to-hush button or automatically, and stores the wanted sounds in a “good” memory. In block 1214, caller A's phone analyzes the sounds stored in the “bad sound” memory and sounds stored in the “good sound” memory to generate filtering criteria. In block 1216, caller A's phone modifies the transmission signal by using the generated filtering criteria to filter out the undesired background noise and sends the modified signal to caller B. In block 1218, caller B receives the transmitted signal with the undesired background noise removed. Thus, in method 1200, caller B presses the push-to-hush button and caller A's phone removes the background noise.

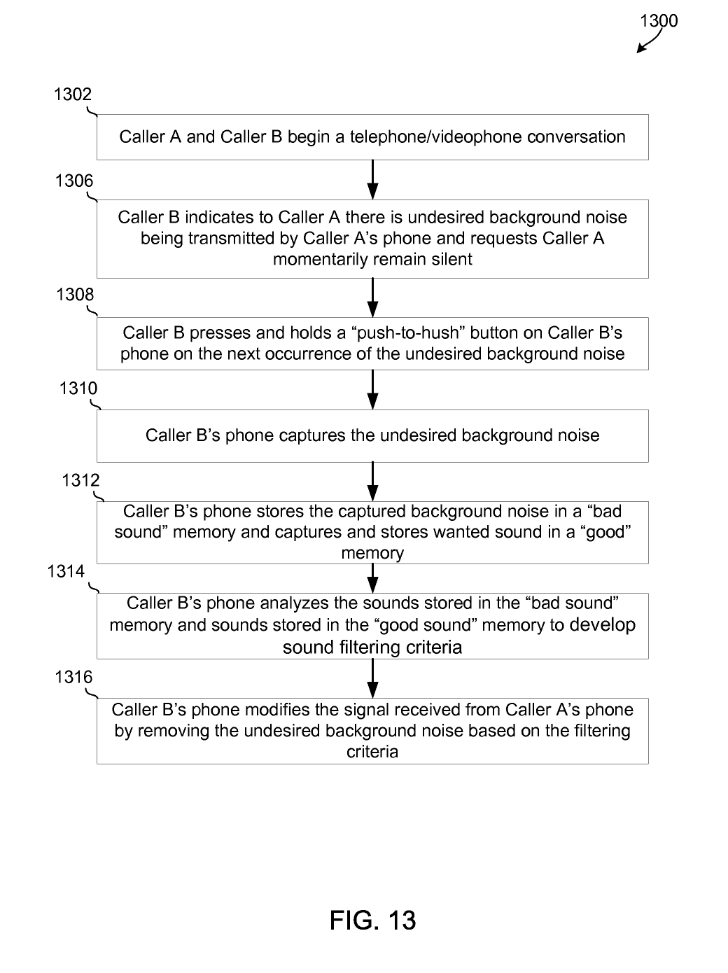

Another embodiment method 1300 for removing background noises is illustrated in FIG. 13. In block 1302, caller A may begin a telephone and/or videophone conversation with caller B. In block 1306, caller B indicates to caller A there is undesired background noise being transmitted by caller A's phone and requests caller A to momentarily remain silent. In block 1308, caller B presses and holds a “push-to-hush” button on caller B's phone during the next occurrence of the undesired background noise. In block 1310, the pressing of the push-to-hush button on caller B's phone instructs caller B's phone to detect and capture sounds received over the open telephone communications link. In block 1312, caller B's phone captures and stores the background sounds as they are transmitted. In block 1314, caller B's phone analyzes the sounds stored in the “bad sound” memory and sounds stored in the “good sound” memory to generate filtering criteria. In block 1316, caller B's phone modifies the received signal by using the generated filtering criteria to filter out the undesired background noise. Thus, in method 1300, Caller B presses the push-to-hush button and Caller B's phone removes the background noise.

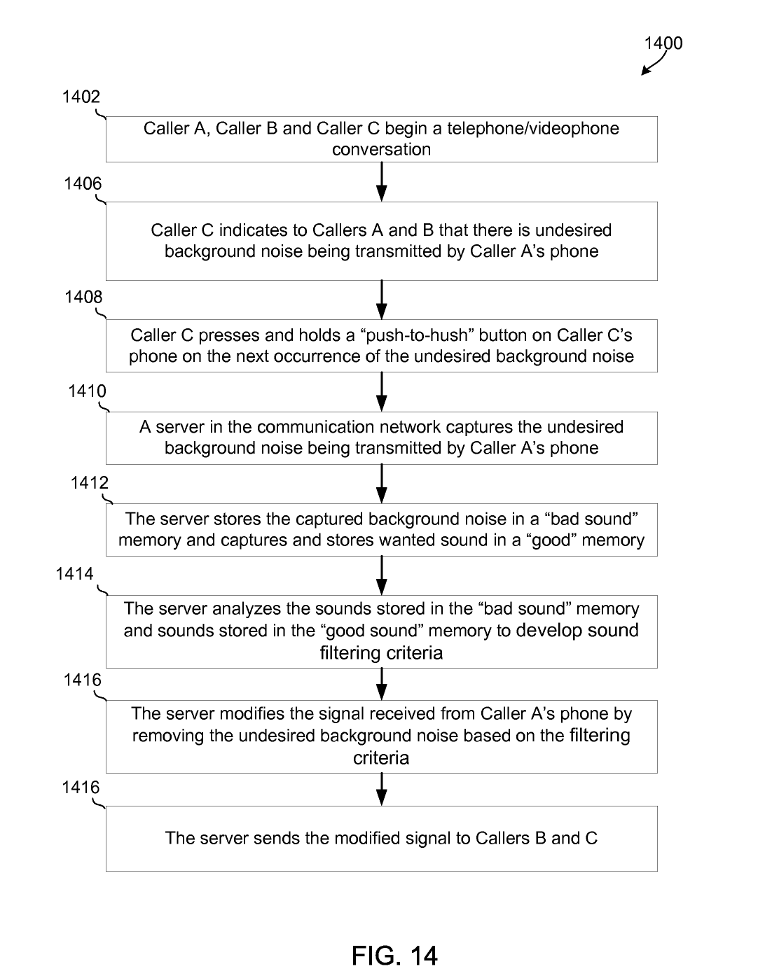

Another embodiment method 1400 for removing background noises is illustrated in FIG. 14. In block 1402, caller A begins a teleconference with caller B and caller C. In block 1406, caller C may indicate to caller A that there is an annoying background noise being transmitted by caller A's phone, and request caller A to momentarily remain quite. In block 1408, caller C presses and holds a “push-to-hush” button on caller C's phone during the next occurrence of the undesired background noise. In block 1410, the pressing of the push-to-hush button on caller C's phone instructs a server in the communication network to capture the undesired background noise and/or wanted sounds being transmitted by caller A's phone. In block 1412, the server captures the background sounds and stores the captured sounds in one or more memories (e.g., “good” memory, “bad” memory, etc.). In block 1414, the server analyzes the sounds stored in the memories to generate filtering criteria. In block 1416, the server modifies the signal transmitted by caller A's phone to filter out the undesired background noise before routing the modified signal to callers B and C. Thus, in method 1400, caller C presses the push-to-hush button and a server removes the background noise.

In an embodiment, captured sounds may be stored in a database and used for filtering in future conversations. A user specific database to store all the captured sounds and/or filtering criteria may be created on any of the components within the communications link, including a server within the network. In this manner, whenever a user engages in another conversation, the user may choose to continue to hush and/or amplify sounds based on the previously designated and stored sounds. In an embodiment, the captured sounds and/or filtering criteria may be stored in a global database such that any component in the system may choose to amplify or hush sounds that have previously been designated for filtering. In another embodiment, the phones may be configured to filter based on any combination of filtering criteria extracted from any combination of global and user specific databases.

The various embodiments may be implemented on either phone (e.g., caller A or caller B), on both phones, or on intermediate servers routing the calls between caller A and caller B. Either phone may initiate the sound capture process and any component (e.g., near end phone, far end phone or server in between the phones) may analyze and filter the annoying sound. For example, if the system is only installed on the far end phone (e.g., caller B), the far end phone may record and actively filter the sound. Likewise, if the system is only installed on the near end phone (e.g., Caller a), the near end phone may record and actively filter the sound before transmission. However, if the system is installed on both phones, the far end phone (e.g., Caller B's phone) may record and filter the sound locally or instruct the server or the near end phone (Caller A's phone) to record the sounds and filter the sounds before they are transmitted. Thus it should be clear from the above examples that, in the various embodiments, the sound may be sampled, recorded and filtered at any point in the communication link between two or more callers.

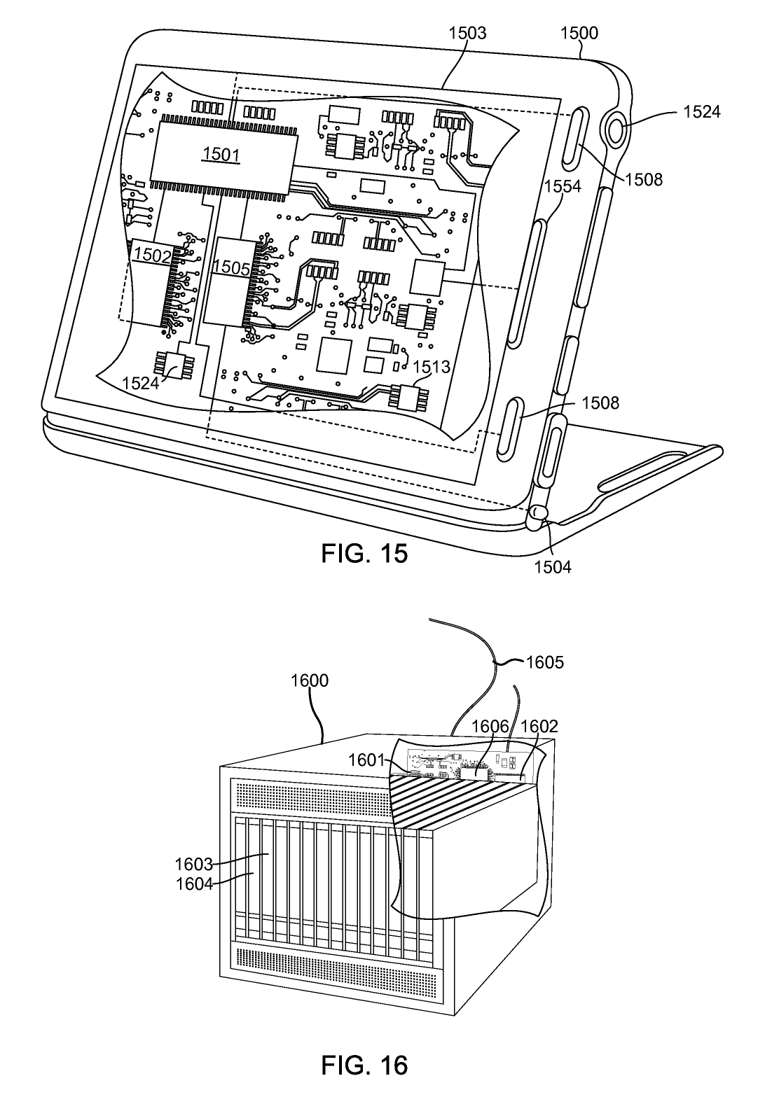

FIG. 15 is a system block diagram of a transceiver device in the form of a phone/cell phone suitable for use with any of the embodiments. A cell phone 1500 may include a processor 1501 coupled to internal memory 1502, a display 1503, and to a speaker 1554. Additionally, the cell phone 1500 may include an antenna 1504 for sending and receiving electromagnetic radiation that may be connected to a wireless data link and/or cellular telephone transceiver 1505 coupled to the processor 1501. Cell phones 1500 typically also include menu selection buttons or rocker switches 1508 for receiving user inputs.

A typical cell phone 1500 includes a sound encoding/decoding (CODEC) circuit 1524 which digitizes sound received from a microphone into data packets suitable for wireless transmission and decodes received sound data packets to generate analog signals that are provided to the speaker 1554 to generate sound. Also, one or more of the processor 1501, wireless transceiver 1505 and CODEC 1524 may include a digital signal processor (DSP) circuit (not shown separately). Processing of stored sound to generate filtering criteria may be accomplished by one or more DSP circuits within the components of the cell phone 1500 using signal analysis methods is well known in the DSP arts. Also, the application of filtering criteria to suppress undesirable sounds and/or enhance desirable sounds may be accomplished by one or more DSP circuits within the components of the cell phone 1500 and/or within the CODEC 1524.

The various embodiments may be implemented within a telecommunications network on any of a variety of commercially available server devices, such as the server 1600 illustrated in FIG. 16. Such a server 1600 typically includes a processor 1601 coupled to volatile memory 1602 and a large capacity nonvolatile memory, such as a disk drive 1603. The server 1600 may also include a floppy disc drive, compact disc (CD) or DVD disc drive 1606 coupled to the processor 1601. The server 1600 may also include network access ports 1604 coupled to the processor 1601 for establishing data connections with a network 1605, such as a local area network coupled to other broadcast system computers and servers. While sound analysis to generate filtering criteria and signal processing to implement the sound filtering may be accomplished by the server processor 1601, in some implementations a DSP module 1607 may be included in the server 1600 to accomplish such processing.

The processors 1501, 1601 may be any programmable microprocessor, microcomputer or multiple processor chip or chips that can be configured by software instructions (applications) to perform a variety of functions, including the functions of the various embodiments described below. In some mobile receiver devices, multiple processors 1601 may be provided, such as one processor dedicated to wireless communication functions and one processor dedicated to running other applications. Typically, software applications may be stored in the internal memory 1502, 1602, 1603 before they are accessed and loaded into the processor 1501, 1601. The processor 1501, 1601 may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a tangible, non-transitory computer-readable storage medium. Tangible, non-transitory computer-readable storage media may be any available media that may be accessed by a computer. By way of example, and not limitation, such, non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of , non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of reducing noise in a voice call between a first and second transceiver device, comprising:
receiving a user input indicating a particular sound for filtering;
activating a microphone on the first transceiver device to capture sounds in response to the user input;
storing the captured sounds in a first memory and a second memory;
processing sounds stored in the first and second memories to develop sound filtering criteria; and
filtering sounds based on the sound filtering criteria.

2. The method of claim 1, wherein the user input is received on the first transceiver device and the filtering sounds is accomplished on the first transceiver device before sound signals are transmitted to the second transceiver device.

3. The method of claim 1, wherein the user input is received on the second transceiver device and sounds are filtered on the first transceiver device before sound signals are transmitted to the second transceiver device.

4. The method of claim 1, wherein the user input is received on the second transceiver device and sounds are filtered on the second transceiver device after the sounds are transmitted from the first transceiver device to the second transceiver device.

5. The method of claim 1, wherein the user input is received on the first transceiver device and sounds are filtered on a server within a communication network between the first and second transceiver devices after the sound signals are transmitted from the first transceiver device and before the sound signals are received by the second transceiver device.

6. The method of claim 1, wherein the user input is received on the second transceiver device and the sounds are filtered on a server within a communication network between the first and second transceiver devices after sound signals are transmitted from the first transceiver device and before the sound signals are received by the second transceiver device.

7. The method of claim 1, wherein the voice call is between the first transceiver device, the second transceiver device and a third transceiver device and the user input is received on the third transceiver device, and wherein the sounds are filtered on a server in a communication network between the first, second and third transceiver devices after sound signals are transmitted from the first transceiver device and before the sound signals are received by the second and third transceiver devices.

8. The method of claim 1, wherein the voice call is between the first transceiver device, the second transceiver device and a third transceiver device and the user input is received on the third transceiver device, and wherein the sounds are filtered on the first transceiver device before sound signals are transmitted from the first transceiver device.

9. The method of claim 1, wherein the voice call is between the first transceiver device, the second transceiver device and a third transceiver device and the user input is received on the third transceiver device, and wherein the sounds are compared and filtered on the third transceiver device after the sounds are transmitted from the first transceiver device.

10. The method of claim 1, wherein the sound filtering criteria is stored in a database.

11. The method of claim 1, wherein filtering sound comprises enhancing sounds similar to those recorded in response to the user input.

12. The method of claim 1, wherein filtering sound comprises suppressing sounds similar to those recorded in response to the user input.

13. The method of claim 1, wherein processing sounds stored in the first and second memories to develop sound filtering criteria comprises identifying frequencies, amplitudes, and time-varying patterns that characterize the stored sounds.

14. The method of claim 1, wherein processing sounds stored in the first and second memories to develop sound filtering criteria further comprises developing the filtering criteria so that sounds are not modified by the filtering if it is determined that the captured background sounds overlap with foreground sounds.

15. The method of claim 1, wherein storing the captured sounds in a first memory and a second memory comprises storing unwanted sounds in the first memory and storing wanted sounds in the second memory.

16. The method of claim 15, wherein processing sounds stored in the first and second memories to develop sound filtering criteria further comprises developing the filtering criteria by comparing sounds in the first memory with sounds in the second memory.

17. The method of claim 1, wherein activating a microphone on the first transceiver device to capture sounds in response to the user input comprises activating the microphone to capture sounds to be stored in the first memory in response to the user input and automatically re-activating the microphone after a predetermined amount of time to capture sounds to be stored in the second memory.

18. The method of claim 14, further comprising continually monitoring incoming sound signals if it is determined that the captured background sounds overlap with foreground sounds to identify segments of the incoming sounds where the captured background sounds do not overlap with foreground sounds.

19. A transceiver device, comprising:
a memory;
a microphone;
a transceiver circuit coupled to the microphone and configured to send and receive signals encoding sound; and
a processor coupled to the memory and to the transceiver circuit, wherein the processor is configured with processor-executable instructions to perform operations comprising:
receiving a user input indicating a particular sound for filtering;
activating the microphone to capture sounds in response to the user input;
storing the captured sounds in a first portion and a second portion of the memory;
processing sounds stored in the first and second portions of the memory to develop sound filtering criteria; and
filtering sounds based on the sound filtering criteria.

20. The transceiver device of claim 19, wherein the processor is configured with processor-executable instructions such that the user input is received in response to a pressing of a button on the transceiver device.

21. The transceiver device of claim 19, wherein the processor is configured with processor-executable instructions such that the user input is received in response to a pressing of a button on a second transceiver device.

22. The transceiver device of claim 19, wherein the processor is configured with processor-executable instructions such that the sound filtering criteria is stored in a database.

23. The transceiver device of claim 19, wherein the processor is configured with processor-executable instructions such that filtering sound comprises enhancing sounds similar to those recorded in response to the user input.

24. The transceiver device of claim 19, wherein the processor is configured with processor-executable instructions such that filtering sound comprises suppressing sounds similar to those recorded in response to the user input.

25. The transceiver device of claim 19, wherein the processor is configured with processor-executable instructions such that processing sounds stored in the first and second portions of the memory to develop sound filtering criteria comprises identifying frequencies, amplitudes, and time-varying patterns that characterize the stored sounds.

26. The transceiver device of claim 19, wherein the processor is configured with processor-executable instructions such that processing sounds stored in the first and second portions of the memory to develop sound filtering criteria further comprises developing the filtering criteria so that sounds are not modified by the filtering if it is determined that the captured background sounds overlap with foreground sounds.

27. The transceiver device of claim 19, wherein the processor is configured with processor-executable instructions such that storing the captured sounds in the first and second portions of the memory comprises storing unwanted sounds in the first portion of the memory and storing wanted sounds in the second portion of the memory.

28. The transceiver device of claim 27, wherein the processor is configured with processor-executable instructions such that processing sounds stored in the first and second portions of the memory to develop sound filtering criteria further comprises developing the filtering criteria by comparing sounds in the first portion of the memory with sounds in the second portion of the memory.

29. The transceiver device of claim 19, wherein the processor is configured with processor-executable instructions such that activating a microphone to capture sounds in response to the user input comprises activating the microphone to capture sounds to be stored in the first portion of the memory in response to the user input and automatically re-activating the microphone after a predetermined amount of time to capture sounds to be stored in the second portion of the memory.

30. The transceiver device of claim 26, wherein the processor is configured with processor-executable instructions to perform operations further comprising:
continually monitoring incoming sound signals if it is determined that the captured background sounds overlap with foreground sounds to identify segments of the incoming sounds where the captured background sounds do not overlap with foreground sounds.

31. A transceiver device comprising:
means for sending and receiving signals encoding sound;
means for receiving a user input indicating a particular sound for filtering;
means for capturing sounds in response to the user input;
means for storing the captured sounds in a first memory and a second memory;
means for processing sounds stored in the first and second memories to develop sound filtering criteria; and
means for filtering sounds based on the sound filtering criteria.

32. The transceiver device of claim 31, wherein means for receiving user input comprises means for receiving the user input in response to a pressing of a button on the transceiver device.

33. The transceiver device of claim 31, wherein means for receiving user input comprises means for receiving the user input from a second transceiver device.

34. The transceiver device of claim 31, wherein means for receiving user input comprises means for receiving the user input in response to a pressing of a button on a second transceiver device.

35. The transceiver device of claim 31, wherein means for receiving user input comprises means for receiving the user input in response to a pressing of a button on the transceiver device.

36. The transceiver device of claim 31, wherein means for receiving user input comprises means for receiving the user input from a second transceiver device.

37. The transceiver device of claim 31, further comprising means for storing the sound filtering criteria in a database.

38. The transceiver device of claim 31, wherein means for filtering sounds comprises means for enhancing sounds similar to those recorded in response to the user input.

39. The transceiver device of claim 31, wherein means for filtering sounds comprises means for suppressing sounds similar to those recorded in response to the user input.

40. The transceiver device of claim 31, wherein means for processing sounds stored in the first and second memories to develop sound filtering criteria comprises means for identifying frequencies, amplitudes, and time-varying patterns that characterize the sounds.

41. The transceiver device of claim 31, wherein means for processing sounds stored in the first and second memories to develop sound filtering criteria comprises means for developing the filtering criteria so that sounds are not modified by the filtering if it is determined that the captured background sounds overlap with foreground sounds.

42. The transceiver device of claim 31, wherein means for storing the captured sounds in first and second memories comprises means for storing unwanted sounds in the first memory and storing wanted sounds in the second memory.

43. The transceiver device of claim 42, wherein means for processing sounds stored in the first and second memories to develop sound filtering criteria further comprises means for developing the filtering criteria by comparing sounds in the first memory with sounds in the second memory.

44. The transceiver device of claim 31, wherein means for capturing sounds in response to the user input comprises means for capturing sounds to be stored in the first memory in response to the user input and means for capturing sounds to be stored in the second memory after a predetermined amount of time after captured sounds are stored in the first memory.

45. The transceiver device of claim 41, further comprising means for continually monitoring incoming sound signals if it is determined that the captured background sounds overlap with foreground sounds to identify segments of the incoming sounds where the captured background sounds do not overlap with foreground sounds.

46. A non-transitory computer readable storage medium having stored thereon processor-executable software instructions configured to cause a processor to perform operations for reducing noise, the operations comprising:
receiving a user input indicating particular sounds for filtering;
activating a microphone to capture sounds in response to the user input;
storing the captured sounds in a first memory and a second memory;
processing sounds stored in the first and second memories to develop sound filtering criteria; and
filtering sounds based on the sound filtering criteria.

47. The non-transitory computer readable storage medium of claim 46, wherein the stored processor-executable software instructions are configured to cause a processor to perform operations such that the user input is received in response to a pressing of a button on the transceiver device.

48. The non-transitory computer readable storage medium of claim 46, wherein the stored processor-executable software instructions are configured to cause a processor to perform operations such that the user input is received in response to a pressing of a button on a second transceiver device.

49. The non-transitory computer readable storage medium of claim 46, wherein the stored processor-executable software instructions are configured to cause a processor to perform operations such that the sound filtering criteria is stored in a database.

50. The non-transitory computer readable storage medium of claim 46, wherein the stored processor-executable software instructions are configured to cause a processor to perform operations such that filtering sound comprises enhancing sounds similar to those captured in response to the user input.

51. The non-transitory computer readable storage medium of claim 46, wherein the stored processor-executable software instructions are configured to cause a processor to perform operations such that filtering sound comprises suppressing sounds similar to those captured in response to the user input.

52. The non-transitory computer readable storage medium of claim 46, wherein the stored processor-executable software instructions are configured to cause a processor to perform operations such that processing sounds stored in the first and second memories to develop sound filtering criteria comprises identifying frequencies, amplitudes, and time-varying patterns that characterize the stored sounds.

53. The non-transitory computer readable storage medium of claim 46, wherein the stored processor-executable software instructions are configured to cause a processor to perform operations such that processing sounds stored in the first and second memories to develop sound filtering criteria further comprises developing the filtering criteria so that sounds are not modified by the filtering if it is determined that the captured background sounds overlap with foreground sounds.

54. The non-transitory computer readable storage medium of claim 46, wherein the stored processor-executable software instructions are configured to cause a processor to perform operations such that storing the captured sounds in first and second memories comprises storing unwanted sounds in the first memory and storing wanted sounds in the second memory.

55. The non-transitory computer readable storage medium of claim 54, wherein the stored processor-executable software instructions are configured to cause a processor to perform operations such that processing sounds stored in the first and second memories to develop sound filtering criteria further comprises developing the filtering criteria by comparing sounds in the first memory with sounds in the second memory.

56. The non-transitory computer readable storage medium of claim 46, wherein the stored processor-executable software instructions are configured to cause a processor to perform operations such that activating a microphone to capture sounds in response to the user input comprises activating the microphone to capture sounds to be stored in the first memory in response to the user input and automatically re-activating the microphone after a predetermined amount of time to capture sounds to be stored in the second memory.

57. The non-transitory computer readable storage medium of claim 53, the stored processor-executable software instructions are configured to cause a processor to perform operations further comprising continually monitoring incoming sound signals if it is determined that the captured background sounds overlap with foreground sounds to identify segments of the incoming sounds where the captured background sounds do not overlap with foreground sounds.

58. A communication system, comprising:
a first transceiver device comprising a first memory, a first microphone, a first transceiver circuit coupled to the first microphone and configured to send and receive signals encoding sound, and a first processor coupled to the first memory and to the first transceiver circuit; and
a second transceiver device comprising a second memory, a second microphone, a second transceiver circuit coupled to the second microphone and configured to send and receive signals encoding sound, and a second processor coupled to the second memory and to the second transceiver circuit, wherein:
the first processor is configured with processor-executable instructions to perform operations comprising:
receiving a user input; and
activating the first microphone to capture sounds in response to the user input.

59. The communication system of claim 58, wherein the user input is received in response to a user pressing a button on the first transceiver device.

60. The communication system of claim 58, further comprising a server having a server memory, a server processor and a communication link in communication with the first and second transceiver devices,
wherein the first processor is configured with processor-executable instructions to perform operations further comprising transmitting the captured sounds to the server, and
wherein the server processor is configured with processor-executable instructions to perform operations comprising:
receiving the captured sounds transmitted by the first transceiver;
storing the received sounds in a first portion and a second portion of the server memory;
processing sounds stored in the first and second portions of the server memory to develop sound filtering criteria; and
filtering sounds based on the sound filtering criteria before the sound signals are received by the second transceiver device.

61. The communication system of claim 58, further comprising a server in communication with the first and second transceiver devices, wherein the first processor is configured with processor-executable instructions to perform operations further comprising:
storing the captured sounds in a first portion and a second portion of the first memory;
processing sounds stored in the first and second portions of the first memory to develop sound filtering criteria; and
transmitting the filtering criteria to the server.

62. The communication system of claim 61, wherein the server is configured to receive the filtering criteria and filter sounds after sound signals are transmitted from the first transceiver device and before the sound signals are received by the second transceiver device.

63. The communication system of claim 62, wherein the sound filtering criteria is stored in a database.

64. The communication system of claim 59, wherein the first processor is configured with processor-executable instructions to perform operations further comprising:
storing the captured sounds in a first portion and a second portion of the first memory;
processing sounds stored in the first and second portions of the first memory to develop sound filtering criteria; and
filtering sounds based on the sound filtering criteria.

65. The communication system of claim 58, wherein the user input is received in response to a user pressing a button on the second transceiver device.

66. The communication system of claim 65, wherein the first processor is configured with processor-executable instructions to perform operations further comprising transmitting the captured sounds to the second transceiver device and the second processor is configured with processor-executable instructions to perform operations comprising:
receiving the captured sounds from the first transceiver device;
storing the captured sounds in a first portion and a second portion of the second memory;
processing sounds stored in the first and second portions of the second memory to develop sound filtering criteria; and
filtering sounds based on the sound filtering criteria.

67. The communication system of claim 65, further comprising a server having a server memory, a server processor and a communication link in communication with the first and second transceiver devices,
wherein the first processor is configured with processor-executable instructions to perform operations comprising transmitting the captured sounds to the server, and
wherein the server processor is configured with processor-executable instructions to perform operations comprising:
receiving the captured sounds transmitted by the first transceiver;
storing the received sounds in a first portion and a second portion of the server memory;
processing sounds stored in the first and second portions of the server memory to develop sound filtering criteria; and
filtering sounds based on the sound filtering criteria before the sound signals are received by the second transceiver device.

68. The communication system of claim 65, wherein the first processor is configured with processor-executable instructions to perform operations further comprising:
receiving from the second transceiver device a signal indicating when the user presses the button on the second transceiver device, wherein activating the first microphone to capture sounds in response to the user input comprises activating the first microphone in response to receiving the signal indicating when the user presses the button on the second transceiver device;
storing the captured sounds in a first portion and a second portion of the first memory;
processing sounds stored in the first and second portions of the first memory to develop sound filtering criteria; and
filtering sounds based on the sound filtering criteria.

69. The communication system of claim 65, further comprising a server in communication with the first and second transceiver devices, wherein the first processor is configured with processor-executable instructions to perform operations further comprising:
storing the captured sounds in a first portion and a second portion of the first memory;
processing sounds stored in the first and second portions of the first memory to develop sound filtering criteria; and
transmitting the filtering criteria to the server.

70. The communication system of claim 69, wherein the server is configured to receive the filtering criteria and filter sounds after sound signals are transmitted from the first transceiver device and before the sound signals are received by the second transceiver device.

71. The communication system of claim 70, wherein the sound filtering criteria is stored in a database stored on the server.

72. The communication system of claim 69, wherein storing the captured sounds in the first and second portions of the first memory comprises storing unwanted sounds in the first portion of the first memory and storing wanted sounds in the second portion of the first memory.

73. The communication system of claim 72, wherein processing sounds stored in the first and second portions of the memory to develop sound filtering criteria further comprises developing the filtering criteria by comparing sounds in the first memory with sounds in the second memory.

74. A transceiver device, comprising:
a memory;
a transceiver circuit configured to send and receive signals encoding sound; and
a processor coupled to the memory and to the transceiver circuit, wherein the processor is configured with processor-executable instructions to perform operations comprising:
receiving a user input indicating a particular sound for filtering;
transmitting a signal to a second transceiver device indicating when the user input is received;
receiving sound filtering criteria from the second transceiver device; and
filtering sounds based on the received sound filtering criteria.

75. A transceiver device, comprising:
means for receiving a user input indicating a particular sound for filtering;
means for transmitting a signal to a second transceiver device indicating when the user input is received;
means for receiving sound filtering criteria from the second transceiver device; and
means for filtering sounds based on the received sound filtering criteria.

76. A non-transitory processor-readable storage medium having stored thereon processor-executable instructions configured to cause a processor of a transceiver device to perform operations comprising:
receiving a user input indicating a particular sound for filtering;
transmitting a signal to a second transceiver device indicating when the user input is received;
receiving sound filtering criteria from the second transceiver device; and
filtering sounds based on the received sound filtering criteria.
